(19) United States
(12) Patent Application Publication
(10) Pub. No.: US 2017/0136477 A1
(43) Pub. Date: May 18, 2017

(54) DEVICE FOR DISPENSING A FLUID PRODUCT

(71) Applicant: APTAR FRANCE SAS, Le Neubourg (FR)

(72) Inventors: Frederic HELDT, Louviers (FR); Baptiste LEBEL, Evreux (FR); Ludovic PETIT, Vitot (FR)

(73) Assignee: APTAR FRANCE SAS, Le Neubourg (FR)

(21) Appl. No.: 15/323,448

(22) PCT Filed: Jul. 2, 2015
(86) PCT No.: PCT/FR2015/051839

§ 371 Date: Jan. 3, 2017

(30) Foreign Application Priority Data
Jul. 4, 2014 (FR) 1456492

(51) Int. Cl. B05B 11/02; B05B 11/00

(52) U.S. Cl. CPC B05B 11/02; B05B 11/0008

(57) ABSTRACT

A fluid dispenser device with a body (1), and an axially movable dispenser head (2). The body receives a reservoir (10) having a tube (11) with a proximal axial opening (12) closed by a stopper (20) and adapted to slide in leaktight manner in the tube (11). The dispenser head includes a cannula (4) connected at one end to the dispenser orifice (3), and provided at its other end with a perforating tip (5) for perforating the stopper. The cannula is inserted into a cannula support (9) secured to the dispenser head and including a borehole with an inside diameter equal to, or a little greater than, the outside diameter of the cannula. The distal end of the cannula support (9) has a projection extending inwards and an inside diameter equal to, or a little less than, the outside diameter of the cannula.

### BACKGROUND OF THE INVENTION

The present invention relates to a fluid dispenser device, and more particularly to a device of the single-dose or two-dose type that is adapted to dispense one or two doses of fluid in a single actuation.

Devices of the single-dose or two-dose type are well known. As can be seen in FIG. 1, they generally comprise a body 1 that receives a reservoir 10 containing one or two doses of fluid, and a dispenser head 2 that is provided with a dispenser orifice 3, and that is axially movable relative to said body 1 during actuation. The reservoir 10 is generally formed by a blind hollow tube 11 having an axial opening 12 that is proximal (relative to the dispenser orifice 3) and that is closed in leaktight manner by a stopper 20. The dispenser head 2 generally includes a cannula or needle 4 of generally cylindrical shape that is connected at one end to said dispenser orifice 3, and that is provided at its other end with a perforating tip 5 that is adapted to perforate said stopper 20 during actuation, the stopper 20 then moving in said reservoir 10 so as to expel the dose(s) of fluid through said cannula 4, towards said dispenser orifice 3. The cannula 4 is generally received in stationary manner, in particular force-fitted into a cannula support 9 that is secured to the dispenser head 2. Document EP 0 546 607 describes a device of this type.

A drawback with prior-art devices relates to the risk of leaks during actuation, which changes the dose dispensed and degrades metering reproducibility between various devices of the same type. In particular, and as can be seen in FIG. 2, the cannula support 9 includes a central borehole 92 that is provided with longitudinal splines 91 that make it possible to insert the cannula 4 without too much friction, while ensuring that said cannula is fastened securely in the cannula support. Any liquid that has leaked from the reservoir, e.g. during actuation, might then flow into said cannula support 9, in particular into the whole of said central borehole 92, which can represent a significant volume.

An object of the present invention is to provide a fluid dispenser device, in particular of the single-dose or two-dose type, that does not have the above-mentioned drawbacks.

Another object of the present invention is to provide a fluid dispenser device, in particular of the single-dose or two-dose type, that improves metering accuracy and metering reproducibility for a plurality of devices of the same type, by limiting the volume that might receive leaks during actuation.

Another object of the present invention is to provide a fluid dispenser device, in particular of the single-dose or two-dose type, that is simple and inexpensive to manufacture and to assemble.

### SUMMARY OF CERTAIN EMBODIMENTS OF THE INVENTION

The present invention thus provides a fluid dispenser device comprising a body, and a dispenser head that is provided with a dispenser orifice and that is axially movable relative to said body during actuation, said body receiving a reservoir containing fluid, said reservoir comprising a hollow tube having a proximal axial opening that is closed by a stopper that is adapted to slide in leaktight manner in said tube during actuation, said dispenser head including a hollow cannula that is connected at one end to said dispenser orifice, and that is provided at its other end with a perforating tip provided with an opening for perforating said stopper, said cannula being inserted into a cannula support that is secured to said dispenser head, said cannula support including a central axial borehole having an inside diameter dl that is equal to, or a little greater than, the outside diameter of said cannula, the distal axial end of said cannula support including a radial projection that extends radially inwards, having an inside diameter d2 that is equal to, or a little less than, the outside diameter of said cannula, the inside diameter d2 of said radial projection being less than the inside diameter d1 of said central axial borehole.

Advantageously, after inserting the cannula into the cannula support, said radial projection co-operates in leaktight manner with said cannula.

Advantageously, the front-end radial surface of the distal axial end of the cannula support is plane, and during actuation it co-operates in leaktight manner with the stopper.

Advantageously, the cannula support is made of two portions, a top portion with a central axial borehole of inside diameter that is constant, and a bottom portion including said radial projection of inside diameter that is smaller.

Advantageously, said reservoir is formed by a blind hollow tube.

Advantageously, said reservoir contains a single dose of fluid for dispensing during a single actuation of the device.

In a variant, said reservoir contains two doses of fluid for dispensing during two successive actuations of the device.

### BRIEF DESCRIPTION OF THE DRAWINGS

These characteristics and advantages and others appear more clearly from the following detailed description, given by way of non-limiting examples, and with reference to the accompanying drawings, and in which:

FIG. 1 is a diagrammatic view of a dispenser device of the two-dose type to which the present invention may be applied;

FIG. 2 is a section view of a detail of a standard cannula of the prior art;

FIG. 3 is a view similar to the view in FIG. 2, showing an advantageous embodiment of the present invention;

FIG. 4 is a section view of a detail of the FIG. 3 cannula support;

FIG. 5 is view of a detail of the FIG. 4 cannula support; and

FIG. 6 is a view of a detail of a cannula support in a variant embodiment.

### DESCRIPTION OF THE PREFERRED EMBODIMENTS

The present invention relates more particularly to a device of the type disclosed in document EP 0 546 607.

However, it should be understood that the present invention is not limited to that type of device, but, on the contrary, applies to any type of fluid dispenser device of the single-dose or two-dose type or of the multi-dose type that includes a reservoir closed by a stopper, said stopper needing to be perforated prior to actuation or at the beginning of actuation.

In the description, the terms “axial” and “radial” are relative in particular to the longitudinal direction of the cylindrical cannula 4. The terms “proximal” and “distal” are relative to the dispenser orifice 3 formed in the dispenser head 2.

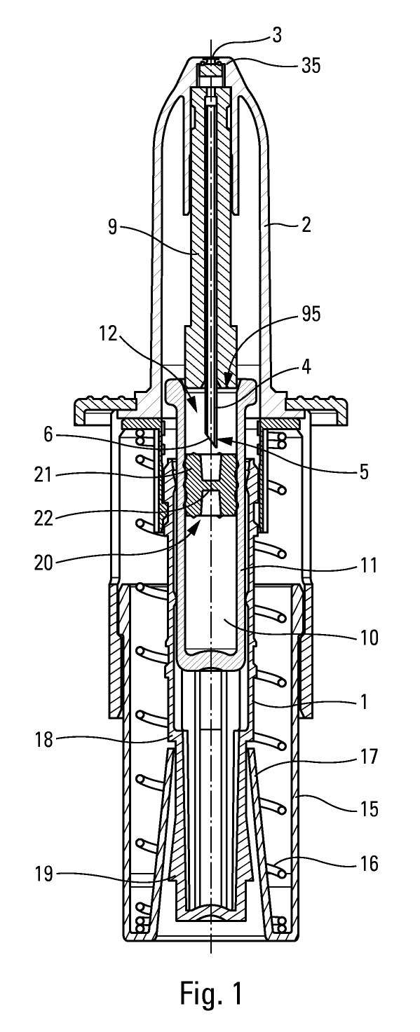

The invention applies more particularly to devices of the single-dose or two-dose type as shown in FIG. 1. As described above, such a device includes a body 1 that receives a reservoir 10 containing one or two doses of fluid, and a dispenser head 2, provided with a dispenser orifice 3, is axially movable relative to said body 1 during actuation.

The reservoir 10 contains one or two doses of fluid. Advantageously, said reservoir 10 is formed by a blind hollow tube 11, e.g. made of glass, having an axial opening 12 that is closed by a stopper 20, e.g. made of elastomer, that is adapted to slide in leaktight manner in said tube 11 during actuation. Said stopper 20 comprises both a tubular axial portion 21 that slides in leaktight manner in the tube 11, and also a transverse wall 22 for being perforated by a cannula 4 during actuation.

The dispenser head 2 generally includes a cannula or needle 4 of generally cylindrical shape that is connected at one end to said dispenser orifice 3, and that is provided at its other end with a perforating tip 5 that is adapted to perforate said stopper 20 during actuation, the stopper 20 thus being moved in said reservoir 10 so as to expel the dose(s) of fluid through said cannula 4, towards said dispenser orifice 3. The cannula 4 is inserted into a cannula support 9 that is itself fastened in said dispenser head 2. Advantageously, a spray profile 35 may be formed directly upstream from the dispenser orifice 3, e.g. between the end wall of said dispenser head 2 and the proximal axial end of said cannula support 9.

An actuator member 15 connected to said body 1 may be provided to perform actuation. In the embodiment shown in FIG. 1, the actuator member 15 is urged towards its rest position by a spring 16, and is movable manually against the force of the spring 16 so as to move both the body 1 and the reservoir 10 relative to the dispenser head 2. Since the embodiment in FIG. 1 is a two-dose dispenser device, the actuator member includes dose-splitting means that, in this embodiment, are in the form of one or more flexible tabs 17 that co-operate with respective radial shoulders 18, 19 formed on said body 1. Thus, in order to dispense the first dose, the flexible tab 17 co-operates with the shoulder 18, then the spring 16 returns the actuator member 15 into its rest position in which said flexible tab co-operates with the second shoulder 19. Other dose-splitting means may be envisaged.

With reference to FIGS. 3 to 5, the cannula support 9 includes a central axial borehole 92 having an inside diameter d1 that may be equal to, or a little greater than, the outside diameter of said cannula 4. At its distal axial end, said cannula support 9 includes a radial projection 90 that extends radially inwards, having an inside diameter d2 that is equal to, or a little less than, the outside diameter of said cannula 4, d2 being less than d1. Thus, inserting the cannula 4 into the cannula support 9 is easy, since significant friction between said cannula support 9 and said cannula 4 occurs only at said radial projection 90.

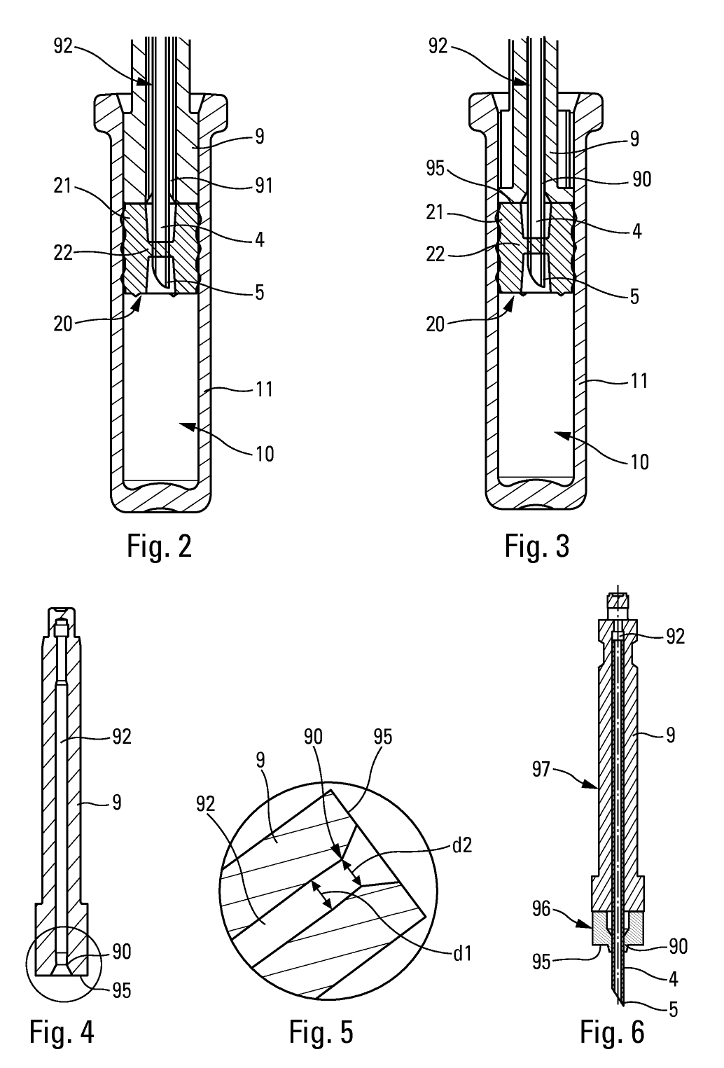

In addition, after the cannula 4 has been inserted, the radial projection 90 co-operates in leaktight manner with said cannula 4, thereby preventing any liquid that has leaked from the reservoir 10 propagating beyond said projection 90. The volume of the space that might receive leaked liquid is thus considerably reduced compared to the prior-art device shown in FIG. 2.

Advantageously, the front-end radial surface 95 of the distal axial end of the cannula support 9 is completely plane, and during actuation it co-operates in leaktight manner with the stopper 20. This also limits the risk of leaks, and the volume of such leaks.

FIG. 6 shows a variant embodiment in which the cannula support 9 is made of two portions, a top portion 97 forming the main portion of the cannula support, with a central axial borehole 92 of inside diameter that is constant, and a bottom portion 96 including the radial projection 90 of inside diameter that is smaller. This embodiment simplifies manufacture, since there is no undercut. The bottom portion 97 may be fastened to the top portion 96 by any appropriate means, such as adhesive-bonding or heat-sealing, or the two portions may be co-molded or over-molded one on the other.

The table below shows the improved performances of the invention compared to a standard device of FIG. 2.

| | Average | | | | Number of | |
|---|---|---|---|---|---|---|
| | All | Standard | | | out-of-spec | Number |
| Dose weight | doses | deviation | | | doses/ | of |
| 220 μl fill | (mg) | All doses | Cp | Cpk | All doses | leaks |
| Two-dose with | 187.2 | 8.1 | 0.8 | 0.3 | 2/30 | 8/30 |
| standard | | | | | | |
| cannula | | | | | | |
| Two-dose with | 187.0 | 2.8 | 2.4 | 0.8 | 0/30 | 8/30 |
| cannula support | | | | | | |
| with leaktight | | | | | | |
| function | | | | | | |

In the table:

Number of samples tested: 30

Cp and Cpk are statistical criteria:

Cp: difference between the upper limit and the lower limit in three dimensional space, multiplied by one sixth of the deviations; the greater Cp, the less the leaks are dispersive; Cp does not take account of the location where the distribution is centered.

Cpk: capability index for testing the quality of a process, while assuming certain specification limits; it is always used in conjunction with Cp; Cpk relates to the location where the distribution is centered; the greater Cpk, the more the dose will be in specification.

Spec: specification; the dose specification is 200±10% (i.e. in the range 180 to 220) on average, 200±15% (i.e. in the range 170 to 230) on individual doses.

The table shows that the present invention improves the performance of the device, reducing leaks and thus increasing metering accuracy and reproducibility.

It should be observed that the invention gives improved performance with standard deviation that is much smaller, Cp and Cpk values that are greater, and a minimum number of out-of-specification doses.

The present invention is described above with reference to advantageous embodiments, but naturally any modification could be applied thereto by a person skilled in the art, without going beyond the ambit of the present invention, as defined by the accompanying claims.

1. A fluid dispenser device comprising a body (1), and a dispenser head (2) that is provided with a dispenser orifice (3) and that is axially movable relative to said body (1) during actuation, said body (1) receiving a reservoir (10) containing fluid, said reservoir (10) comprising a hollow tube (11) having a proximal axial opening (12) that is closed by a stopper (20) that is adapted to slide in leaktight manner in said tube (11) during actuation, said dispenser head (2) including a hollow cannula (4) that is connected at one end to said dispenser orifice (3), and that is provided at its other end with a perforating tip (5) provided with an opening (6) for perforating said stopper (20), said cannula (4) being inserted into a cannula support (9) that is secured to said dispenser head (2), the device being characterized in that said cannula support (9) includes a central axial borehole (92) having an inside diameter (d1) that is equal to, or a little greater than, the outside diameter of said cannula (4), the distal axial end of said cannula support (9) including a radial projection (90) that extends radially inwards, having an inside diameter (d2) that is equal to, or a little less than, the outside diameter of said cannula (4), the inside diameter (d2) of said radial projection (90) being less than the inside diameter (d1) of said central axial borehole (92).

2. A device according to claim 1, wherein, after inserting the cannula (4) into the cannula support (9), said radial projection (90) co-operates in leaktight manner with said cannula (4).

3. A device according to claim 1, wherein the front-end radial surface (95) of the distal axial end of the cannula support (9) is plane, and during actuation it co-operates in leaktight manner with the stopper (20).

4. A device according to claim 1, wherein the cannula support (9) is made of two portions, a top portion (97) with a central axial borehole (92) of inside diameter that is constant, and a bottom portion (96) including said radial projection (90) of inside diameter that is smaller.

5. A device according to claim 1, wherein said reservoir (10) is formed by a blind hollow tube (11).

6. A device according to claim 1, wherein said reservoir (10) contains a single dose of fluid for dispensing during a single actuation of the device.

7. A device according to claim 1, wherein said reservoir (10) contains two doses of fluid for dispensing during two successive actuations of the device.
